(19) United States
(12) Patent Application Publication
(10) Pub. No.: US 2008/0313193 A1
(43) Pub. Date: Dec. 18, 2008

(54) Method of providing information to the public

(75) Inventors: Jacob Mestman, Portland, OR (US); Phil Wells, Boring, OR (US)

Correspondence Address: OLYMPIC PATENT WORKS PLLC, P.O. BOX 4277, SEATTLE, WA, 98104, US

(73) Assignee: Jacob Mestman

(21) Appl. No.: 12/150,882

(22) Filed: Apr. 30, 2008

Related U.S. Application Data
(60) Provisional application No. 60/927,164, filed on May 1, 2007.

(51) Int. Cl. G06F 17/30; E04B 1/00

(52) U.S. Cl. 707/10; 52/745.19; 707/E17.001

(57) ABSTRACT

An information access kiosk includes a computer assembly, including a wireless internet connection and an energy storage assembly, capable of powering the computer. Also, a protective assembly is adapted to permit the kiosk to withstand the attack of earthly elements when placed outside and a computer program, resident on the computer, is adapted to facilitate use of the computer to permit at least one anticipated use by a user.

### RELATED APPLICATIONS

This application claims priority from provisional application Ser. No. 60/927,164, filed May 1, 2007, which is incorporated by reference as if fully set forth herein.

### BACKGROUND

Information can be a very valuable, and sometimes difficult to obtain, resource. Many who dwell in underprivileged areas do not have the financial resources to pay for Internet service, or to purchase a personal computer. This is unfortunate, because this is exactly the group that has the most need of accessing the Internet to obtain social services information. Many government offices are open only from 9 AM to 5 PM, potentially putting great stress on the working poor, who may have difficulty obtaining transportation to government facilities and being able to get time off from work to attend to tasks requiring contact with government agencies. Also, the lack of access to information also puts a stress on government agencies. They must spend more employee time on answering telephone calls to field questions that the caller could have found answers to on the Internet, if only the caller had Internet access.

When a disaster strikes, however, even those who normally have Internet access can be deprived of this resource, due to an electric power outage, just at the moment when the need for information regarding the availability of resources may be at its greatest. Although great efforts may be launched to get food, water and shelter to these people, the need for information, for example, on the location and condition of loved ones, could be the greatest perceived need that person has.

### SUMMARY

In a first separate aspect, the present invention may take the form of an information access kiosk including a computer assembly that provides a wireless internet connection and an energy storage assembly, capable of powering the computer. Also, a protective assembly is adapted to permit the kiosk to withstand attack of earthly elements when placed outside and a computer program, resident on the computer, is adapted to facilitate use of the computer to permit at least one anticipated use by a user.

In a second separate aspect, the present invention may take the form of a method of providing social service information to the public, comprising providing a free-of-charge Internet terminal providing access to a select group of social service websites.

### BRIEF DESCRIPTION OF THE FIGURES

FIG. 1 is a perspective view of an information access point (IAP) kiosk according to the present invention.

FIG. 2 is a block diagram illustrating the power and electrical systems of the kiosk of FIG. 1

FIG. 3 is a perspective view of the kiosk of FIG. 1, with a clam shell panel opened to reveal interior elements.

FIG. 3A is a detail view of a closure element of the kiosk of FIG. 3, the location of which is indicated by circle 3A of FIG. 3.

FIG. 3B is a detail view of the battery tray of the kiosk of FIG. 3, the location of which is indicated by circle 3B of FIG. 3.

FIG. 3C is a detail sectional view of the roof of the kiosk of FIG. 3, taken along line 3C-3C of FIG. 3.

FIG. 4 is a perspective view of the kiosk of FIG. 1, with the electrical cabinet cover removed, revealing interior electrical elements.

FIG. 4A is a downwardly looking sectional view of the kiosk of FIG. 4, taken along line 4A-4A of FIG. 4.

FIG. 4B is a detail view of a portion of the kiosk of FIG. 4, the location of which is indicated by circle 4B-4B of FIG. 4.

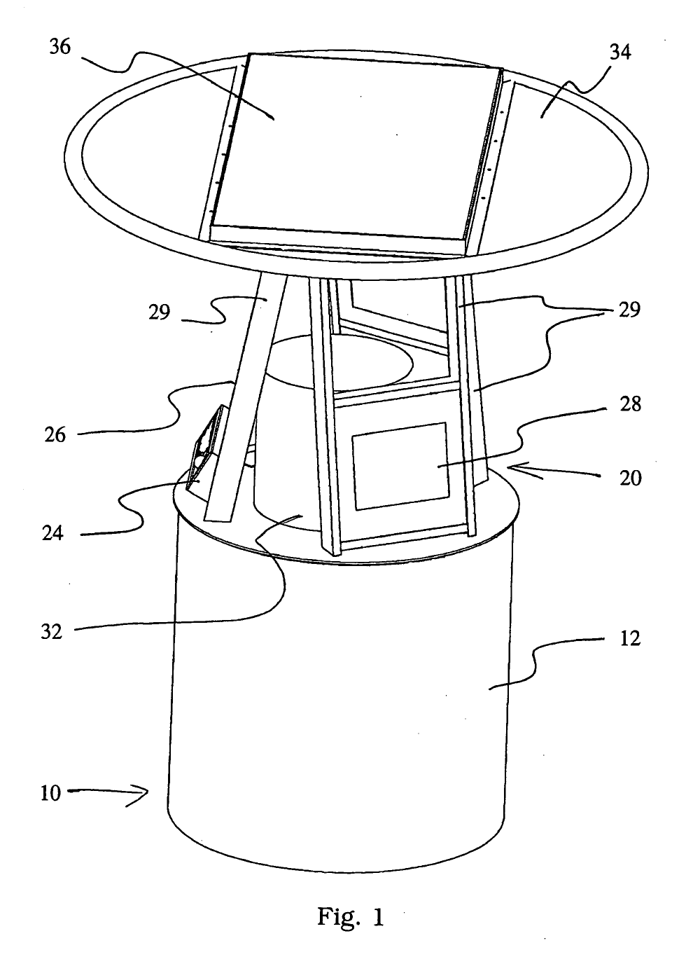

Exemplary embodiments are illustrated in referenced attachments. It is intended that the embodiments and figures disclosed herein are to be considered illustrative rather than restrictive.

### DETAILED DESCRIPTION OF THE PREFERRED EMBODIMENTS

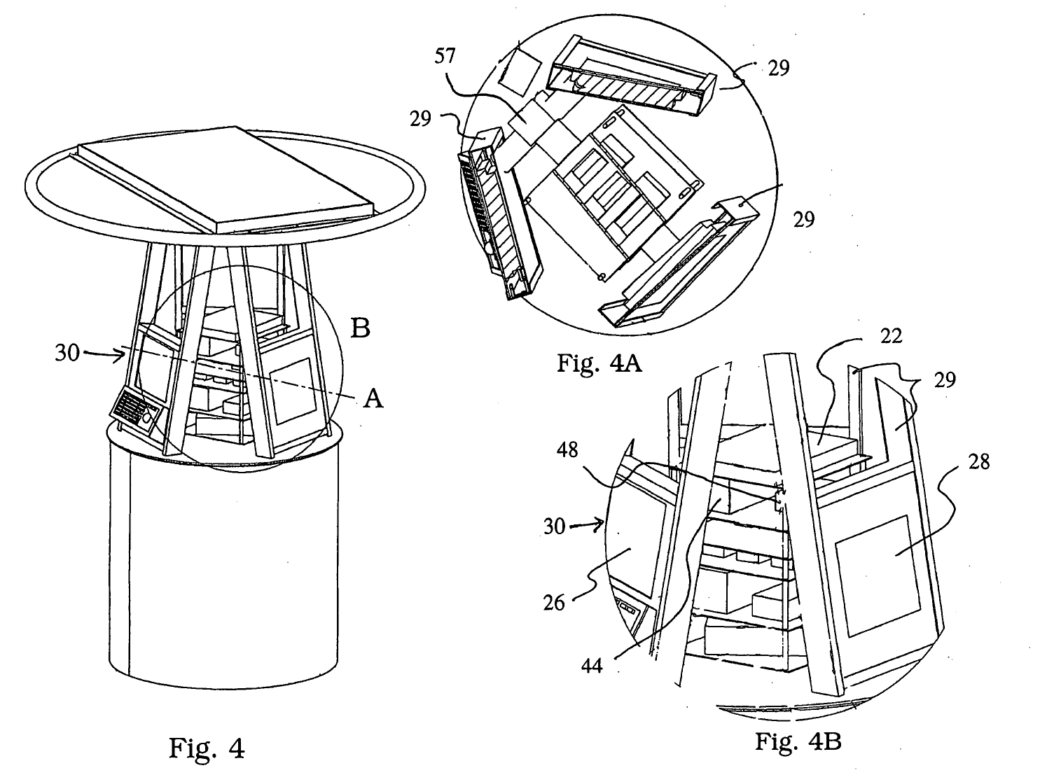

In a preferred embodiment, an Information Access Point (IAP) kiosk 10 includes a main body 12, containing a power assembly 14. A middle portion 20 includes an internet terminal computer 22 including a weatherproof keyboard 24 that includes a trackball, and a display monitor 26, which together with two side display monitors 28 are all held in place by a set of oblique rail pairs 29. All monitors 26 and 28 are protected by a sheet of transparent protective material, such as Plexiglas. An electrical and control assembly 30 (FIG. 4) is protected by a canister 32. Oblique rails 29 also support a roof 34 that supports a set of solar panels 36.

Kiosk 10 may be broken up into component pieces, none of which has a mass of more than 59 Kg (weight of 130 lbs). Accordingly kiosk 10 can be shipped to a destination in a set of boxes (with each packed box having a mass of only about a Kg more than the weight of the packed component), so that it could be handled by a person equipped with a hand truck. Once at the desired location, it can be assembled and put into service by a pair of reasonably strong people in about an hour. Once assembled, it is self powered by a small, lightweight propane powered electrical generator 40 (supplied by a propane tank 41), eight batteries comprising a battery pack 42 (on a wheeled tray 43), and one solar panel 36. Accordingly, the only external input is sunlight, used to slow the draining of the propane tank 41 and battery pack 42. The fact that off-grid operation is possible (indeed generally the preferred mode), greatly expands the possible application of kiosk 10. This is of particular benefit when kiosk 10 is used to facilitate disaster relief operations, as electrical power is frequently unavailable in an area that has been stricken with a disaster. In a preferred embodiment a power plug is provided to plug kiosk 10 into the electrical grid, where it is available. In an additional preferred embodiment kiosk 10 is always self-powered.

In a preferred embodiment, kiosk 10 meets the National Electrical Manufacturers Association (NEMA) 4× standard for an enclosure that is watertight, dust tight and corrosion-resistant, for indoor and outdoor use. This standard is available on request from NEMA. Because of these design qualities, kiosk 10 may generally be left outside without damage to its internal components.

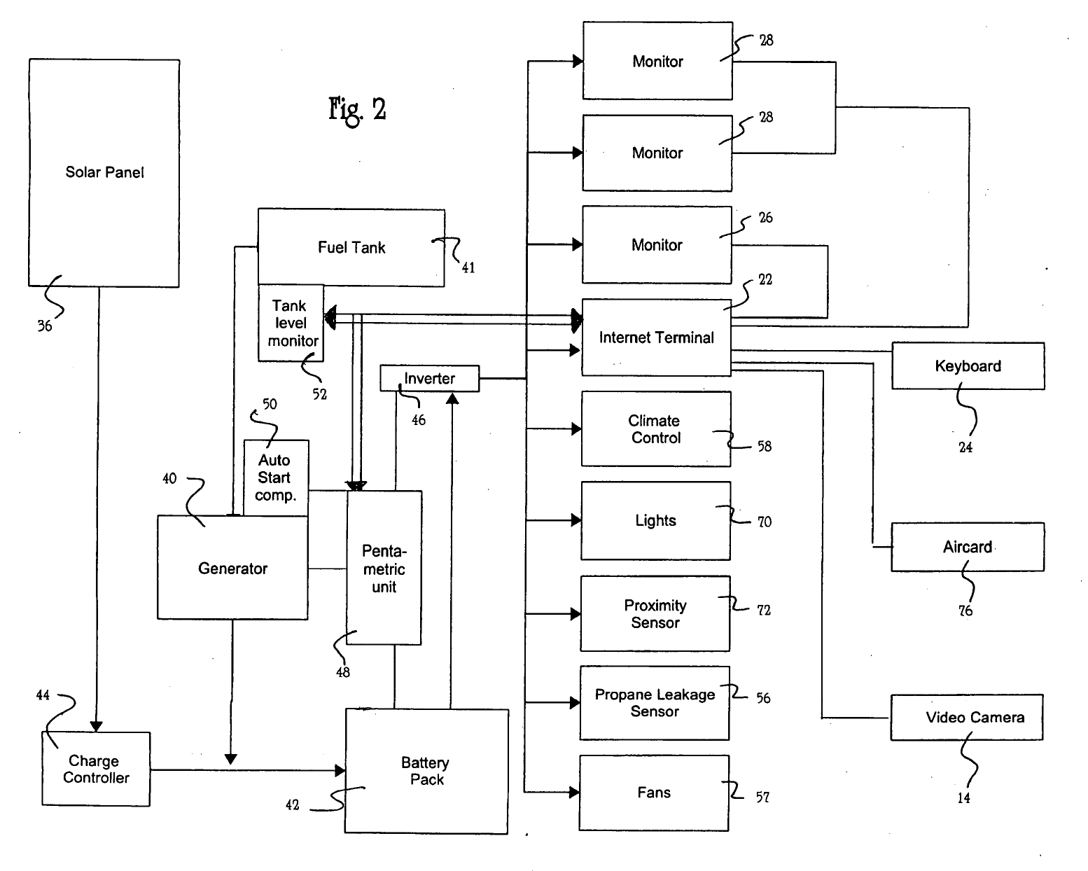

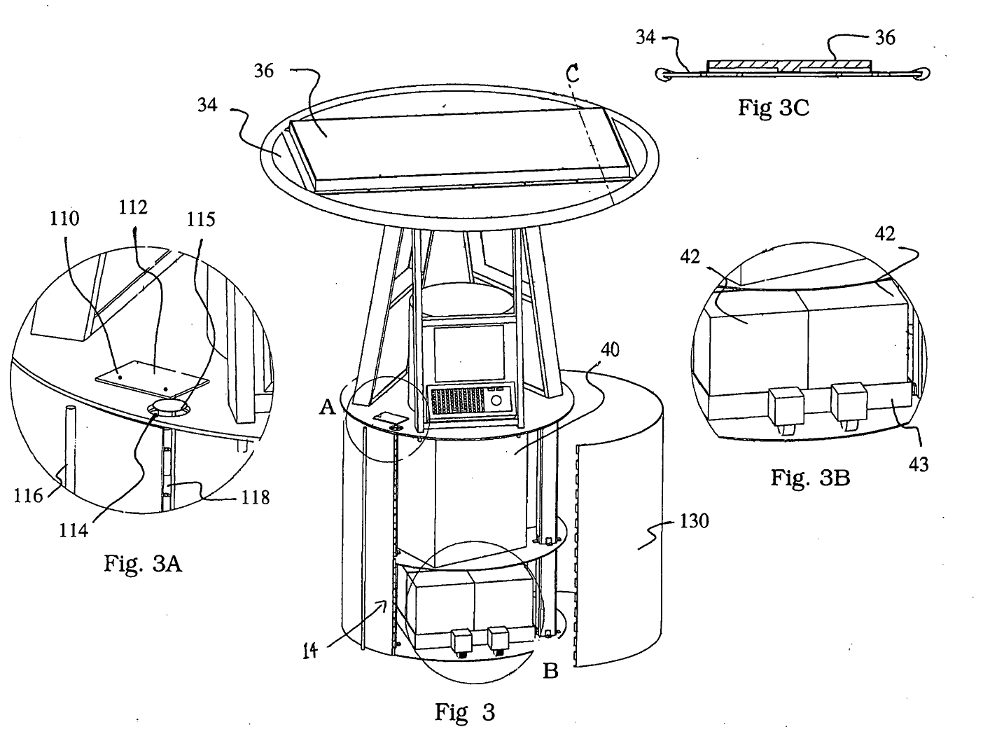

Referring to FIG. 2, a solar panel 36, drives a charge controller 44 that produces a voltage appropriate for charging the battery pack 42. An inverter 46 converts the power into standard 110 V, 60 Hz AC power, so that standard components can be used. An electrical monitoring unit 48 (in one preferred embodiment the model monitoring unit used is available from Bogart Engineering [www.bogartengineering.com] under the trademark “PentaMetric”) monitors the charge of the batteries and turns the generator on and off as needed, using a generator autostart component 50. As well as monitoring charge of batteries, the monitoring unit 48 also monitors and reports data on the inverter 46, the charge controller 44 and a tank level monitor 52, which monitors the propane fuel tank 41. A propane leakage monitor 56 prompts computer 22 to send an Email to maintenance personnel so that the kiosk can be serviced. An auditory alarm may sound under these circumstances to ward would-be users away from kiosk 10.

The resulting information feeds into the computer 22, which is executing tracking software and which maintains a log of system activity. This enables internal components of kiosk 10 to be controlled and monitored via a remote network connection. Fans 57 located throughout the unit keep the equipment in the unit cool. A climate control device 58 is optional and is warranted if the kiosk 10 is to be placed in a hot location. Lights 70 are controlled by a proximity sensor 72 which recognizes when a person approaches the kiosk 10 and activates the lights in response. Additionally, the kiosk 10 includes a video camera 74, controlled by the unit interface software and which allows users to create and send pictures or videos to family and friends.

Internet connectivity to the unit is provided through a card 76 that connects to the internet through a cellular telephone system. Such systems are widely available, and in a preferred embodiment an account is prearranged with a cellular telephone provider to provide unlimited access to an Internet service provider 24 hours a day, 7 days a week anywhere within range of a cellular phone tower. In one preferred embodiment the card used for Internet connectivity is available through Sierra Wireless (Internet address www.sierrawireless.com) under the trademark “aircard.”

In a preferred embodiment monitor 26 of computer 22 is used for viewing the Internet and the two side monitors 28 are used to display sponsor banner advertisements. In an alternative preferred embodiment two additional keyboards are provided and all. three monitors 26 and 28 are used for the Internet.

The kiosk 10 user interface is programmed to default to a custom website, which is designed for a specific purpose. For survey taking applications, the website is configured to prompt user responses, whereas for a social services application, the website is configured to make those social services that are anticipated to be in demand in the deployment area readily and easily available. For a disaster relief application, the custom website would include a link to the most likely to be needed part of the Federal Emergency Management Agency (FEMA) and a website designed to match together separated persons. In a preferred embodiment user access is restricted to approved community interest and/or social services information websites, for example the FEMA website or the Social Security website. In an alternative preferred embodiment, the kiosk 10 would serve as a guide to local businesses. In another preferred embodiment the kiosk 10 would provide a listing of local events and sell tickets to these events.

The kiosk 10 is made as secure as possible against vandalism. Towards this end, to gain physical access to the interior of the main body 12 of the kiosk 10 it is necessary to unfasten a number of special threaded fasteners 110 holding a top plate 112 in place. Threaded fasteners 110 can only be unfastened using a proprietary screw driver that is not generally available to the public. Once top plate 112 is removed, an aperture 114 provides access to a deadbolt lock 115 and lock bar 116 (shown removed) that is threaded through a locking hinge 118, which keeps a pair of clam shell sides 130 of the kiosk main body 12 fastened together. Removing the lock bar 116 permits the clam shell sides 130 to be separated at locking hinge 118 and opened up. The back of the kiosk 10 has a secure door that houses fuel tank 41.

In an alternative preferred embodiment, a kiosk is provided that does not include the generator 40 and propane tank 41, but relies entirely on solar panels 36 and batteries 42 for its supply of power. The principal reason for this is that propane is flammable and may not be permitted in unattended form in some areas. Also, there are some restrictions on the shipment of propane as a flammable substance. Accordingly, if it was desired to send a kiosk 10 to a third world country to provide Internet connectivity to a village, the shipment of the propane might present a significant obstacle. The wheels on battery pack 42 provide a substantial advantage in the case where there is no propane generator, as it makes it easier to replace drained batteries. In one preferred embodiment, kiosks 10 are kept in a state of readiness and deployed after a disaster, such as hurricane or earthquake strikes to enable victims to contact social services agencies more easily. In a preferred embodiment a government agency deploys the kiosks 10, but in another preferred embodiment a nongovernmental organization, such as the Red Cross, deploys the kiosks 10. In another preferred embodiment a for-profit sponsor would provide the kiosks 10 and use this as an advertising opportunity. In a preferred embodiment the terminals are decorated with advertising imagery and the side monitors are used for advertising display. In an alternative preferred embodiment, the main monitor is used to display the advertising of the IAP sponsor. In another preferred embodiment, the IAP is an internet terminal that is provided in a structure, to protect it from the weather. The IAP may also take the form of a standard personal computer, having a wireless Internet connection and being powered by a transportable generator. In yet another preferred embodiment, a wireless system is deployed in the disaster stricken area, prior to the deployment of the IAPs.

In an additional preferred embodiment, the IAPs are deployed in areas in which many people do not have Internet terminals, to facilitate access to social service agencies, and other websites that would be beneficial to people who do not have Internet access from their homes. In a preferred embodiment, terminals are placed in lower socioeconomic status areas, where the need to make contact with and gain information about social welfare programs is the greatest. These terminals could include television camera surveillance, to prevent vandalism and to safeguard users. The availability of these terminals could also reduce telephone and office meeting time required from social service agencies, as the social service users could gain information over the Internet, rather than by telephoning the social service agency, or traveling to it.

While a number of exemplary aspects and embodiments have been discussed above, those possessed of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. An information access kiosk, comprising:
(a) a computer assembly, including a wireless internet connection;
(b) an energy storage assembly, capable of powering said computer;
(c) a protective assembly, adapted to permit said kiosk to withstand attack of earthly elements when placed outside; and
(d) a computer program, resident on said computer, adapted to facilitate use of said computer to permit at least one anticipated use by a user.

2. The information access kiosk of claim 1, wherein said anticipated use by a user is accessing social services information and said computer program displays a list of social service agencies.

3. The information access kiosk of claim 1, wherein said anticipated use by a user is to provide survey information, and said computer program presents said user with a set of survey questions.

4. The information access kiosk of claim 3, wherein said anticipated use by a user is to provide survey information regarding a movie, and said computer program presents said user with a set of survey questions regarding a movie.

5. The information access kiosk of claim 3, wherein said anticipated use by a user is to provide survey information regarding a restaurant, and said computer program presents said user with a set of survey questions regarding a restaurant.

6. The information access kiosk of claim 1, wherein said anticipated use by a user is accessing disaster relief information, subsequent to a disaster, and said computer displays a list of disaster relief resources.

7. The information access kiosk of claim 6, wherein said anticipated use by a user is finding the location of other persons and said computer program displays a person matching site.

8. The information access kiosk of claim 1, wherein said anticipated use by a user is searching for business services and said computer program presents a display adapted to help a user locate business services.

9. The information access kiosk of claim 8, wherein said business services are located in a business district in which said kiosk is located.

10. The information access kiosk of claim 1, which is self-powered by way of fuel that undergoes a chemical reaction.

11. The information access kiosk of claim 10, wherein said chemical fuel is hydrocarbon fuel.

12. The information access kiosk of claim 11, wherein said hydrocarbon fuel powers an electrical generator, which in turn powers said computer.

13. The information access kiosk of claim 11, wherein said electrical generator is powered by an internal combustion engine that burns said hydrocarbon fuel.

14. The information access kiosk of claim 11, wherein said hydrocarbon fuel is propane.

15. The information access kiosk of claim 1, which is at least in part self-powered by a battery.

16. The information access kiosk of claim 1, which is at least in part solar powered.

17. The information access kiosk of claim 1, further being transportable.

18. The information access kiosk of claim 1, wherein information access is limited to selected websites.

19. A method of providing social service information to the public, comprising providing a free-of-charge Internet terminal providing access to a select group of social service websites.

20. The method of claim 19, wherein said social service websites are disaster relief websites.

21. A method of providing a self-powered Internet kiosk, comprising:
(a) providing an Internet kiosk kit made up of separate kit pieces packed in boxes, including:
(i) a roof bearing solar panels;
(ii) a battery assembly;
(iii) a charge controller connected and adapted to charge said battery assembly from electric power provided from said solar panels;
(iv) a computer having a wireless Internet connection; and
(v) a protective shell;
(b) wherein no said packed kit piece box has a mass of more than 80 Kg;
(c) removing said kit pieces from said kit piece boxes; and
(d) assembling said pieces together to form said self-powered Internet kiosk.

22. The method of claim 21 wherein no said packed kit piece box has a mass of greater than 70 Kg.
